(19) United States
(12) Patent Application Publication
(10) Pub. No.: US 2025/0157172 A1
(43) Pub. Date: May 15, 2025

(54) SYSTEMS AND METHODS FOR EQUIVARIENCE IN THREE-DIMENSIONAL (3D) TRANSFORMATIONS

(71) Applicant: TOYOTA RESEARCH INSTITUTE, INC., LOS ALTOS, CA (US)

(72) Inventors: YINSHUANG XU, Philadelphia, PA (US); VITOR GUIZILINI, Santa Clara, CA (US); SERGEY ZAKHAROV, Menlo Park, CA (US); RARES A. AMBRUS, San Francisco, CA (US); ADRIEN D. GAIDON, San Jose, CA (US); DIAN CHEN, Mountain view, CA (US); KATHERINE Y. LIU, Mountain View, CA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 18/652,569

(22) Filed: May 1, 2024

Related U.S. Application Data
(60) Provisional application No. 63/597,413, filed on Nov. 9, 2023.

(51) Int. Cl. G06V 10/24; G06V 10/46; G06V 10/77; G06V 20/58

(52) U.S. Cl. CPC G06V 10/242; G06V 10/46; G06V 10/7715; G06V 20/58

(57) ABSTRACT

Systems and methods for enhanced computer vision capabilities, particularly including 3D transformation equivariance, which may be applicable to autonomous vehicle operation are described. A vehicle may be equipped with an 3D transformation equivariance architecture for performing equivariance of image data in the 3D space for image analysis and computer vision functions. The 3D Transformation Equivariance system and method can be configured to replace Fourier positional embedding with spherical harmonics, ensuring equivariance to 3D rotations for the input embedding. Furthermore, the 3D Transformation Equivariance system can be designed with varying architectures that utilize equivariant self-attention and cross-attention modules that are tailer to the spherical harmonics embedding within the general architecture.

### CROSS-REFERENCE TO RELATED APPLICATION

This application is a non-provisional patent application of U.S. Provisional Patent Application No. 63/597,413, filed Nov. 9, 2023, which is herein incorporated by reference.

### TECHNICAL FIELD

The present disclosure relates to systems and methods supporting enhanced computer vision capabilities which may be applicable to autonomous vehicle operation, for example providing equivariance in three-dimensional (3D) transformations.

### BACKGROUND

Computer vision is a technology that involves techniques which enable computers to gain high-level understanding from digital images and/or videos. For example, a computer system that is executing computer vision can autonomously perform various acquisition, processing, and analysis tasks using digital images and/or video, thereby extracting high-dimensional data from the real-world. There are several different types of technologies that fall under the larger umbrella of computer vision, including: depth synthesis; depth estimation; scene reconstruction; object detection; event detection; video tracking; three-dimensional (3D) pose estimation; 3D scene modeling; motion estimation; and the like.

Computer vision is also at the core of autonomous vehicle technology. For instance, autonomous vehicles can employ computer vision capabilities and leverage object detection algorithms in combination with advanced cameras and sensors to analyze their surroundings in real-time. Accordingly, by utilizing computer vision, autonomous vehicles can recognize objects and surroundings (e.g., pedestrians, road signs, barriers, and other vehicles) in order to safely navigate the road. Continuing advancements in vehicle cameras, computer vision, and Artificial Intelligence (AI) have brought autonomous vehicles closer than ever to meeting safety standards, earning public acceptance, and achieving commercial availability. Moreover, recent years have witnessed enormous progress in AI, causing AI-related fields such as computer vision, machine learning (ML), and autonomous vehicles to similarly become rapidly growing fields.

### BRIEF SUMMARY OF EMBODIMENTS

According to various embodiments in the disclosed technology, a vehicle is disclosed herein that includes a processor device configured for synthesizing depth views at multiple viewpoints. The multiple viewpoints are associated with image data of a surrounding environment for the vehicle. The system further includes a controller device receiving depth views from the processor device. Additionally, the controller device performs autonomous operations in response to analysis of the depth views.

In another embodiment, a system is disclosed that includes an encoder that is configured for encoding image embeddings and camera embeddings and outputting encoded information. The system also includes a decoder that is configured for producing view synthesis estimations and depth synthesis estimations at multiple viewpoints from the encoded information.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The technology disclosed herein, in accordance with one or more various implementations, is described in detail with reference to the following figures. The figures are provided for purposes of illustration only and merely depict typical or example implementations of the disclosed technology. These figures are provided to facilitate the reader's understanding of the disclosed technology and shall not be considered limiting of the breadth, scope, or applicability thereof. It should be noted that for clarity and ease of illustration these figures are not necessarily made to scale.

FIG. 1 illustrates an example vehicle with which embodiments of the disclosure may be implemented.

FIG. 2 illustrates an example vehicle configured for partially controlling operation of the vehicle based on the computer vision capabilities implemented by a three-dimensional (3D) Transformation Equivariance component, in accordance with one or more implementations disclosed herein.

FIG. 3 illustrates an example architecture for the 3D Transformation Equivariance component of the vehicle depicted in FIG. 2, in accordance with one or more implementations disclosed herein.

FIG. 4 illustrates another example architecture for the 3D Transformation Equivariance component of the vehicle depicted in FIG. 2, in accordance with one or more implementations disclosed herein.

FIG. 5 illustrates another example architecture for the 3D Transformation Equivariance component of the vehicle depicted in FIG. 2, in accordance with one or more implementations disclosed herein.

FIG. 6 illustrates example of 3D images that can be generated as a result of equivariance to 3D rotations implemented by the 3D Transformation Equivariance component in FIG. 2, in accordance with one or more implementations disclosed herein.

FIG. 7 illustrates an example computing system with which embodiments may be implemented.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

As referred to herein, computer vision is technology that is related to the acquisition, processing, and analysis of image data, such as digital images and/or video, for the extraction of a high-level and high-dimensional data representing the real-world. Estimating 3D structure from a pair of images is a cornerstone problem of computer vision.

Equivariance is a concept in mathematics, particularly in the context of group theory and symmetry. Generally, equivariance often refers to the property of where a function's output remains related to its input in a consistent way when both the input and the output undergo the same transformation. This concept is often applicable in a wide range of fields, including signal processing, image analysis, and deep learning (e.g., design models that respect the inherent symmetry in data).

Particularly in the realm of 3D image analysis, equivariance with respect to 3D transformations relates to the function or transformation preserving the relationship between points or objects in 3D space when they undergo the same 3D transformation. For example, in a 3D rotation transformation, a function that is equivariant to this transformation would ensure that the relative positions and orientations of the objects in 3D space remain consistent after the rotation. Equivariance is particularly important in computer vision areas (e.g., autonomous vehicles) and 3D modeling, where maintaining the geometric and spatial relationships is crucial for accurate and meaningful data analysis or rendering. Thus, realizing mechanisms that properly achieve equivariance is key to ensuring that 3D data processing and transformations, for instance in automotive applications, respect the underlying symmetries and structure of the 3D world.

Accordingly, the disclosed embodiments provide 3D transformation equivariance system and techniques that utilize a versatile network architecture and have wide-ranging applications in vision and robotics tasks, enabling seamless processing of diverse inputs and outputs in the 3D space. Recently, research has led to development of an architecture to encode geometric priors rather than enforcing constraints, leading to impressive outcomes in depth estimation, optical flow prediction, and novel view synthesis. These methods outperform contemporary approaches by harnessing a powerful implicit representation enriched with essential geometric information. However, incorporating geometric information in this manner results in a lack of equivariance to simultaneous transformations of input and output, a vital property for effective 3D learning. Although some attempts to approximate equivariance through extensive data augmentation have been made, it remains an unsolved challenge. To address this issue, the 3D Transform Equivariance System, as disclosed herein, achieves true equivariance to 3E(3) transformations by design, without relying solely on data augmentation.

Embodiments of the present disclosure are directed to a 3D Transformation Equivariance system and method that are configured to replace the Fourier positional embedding with Spherical Harmonics, ensuring equivariance to 3D rotations for the input embedding. Furthermore, the 3D Transformation Equivariance system can be designed with varying architectures that utilize equivariant self-attention and cross-attention modules tailored to the Spherical Harmonics embedding within the general architecture.

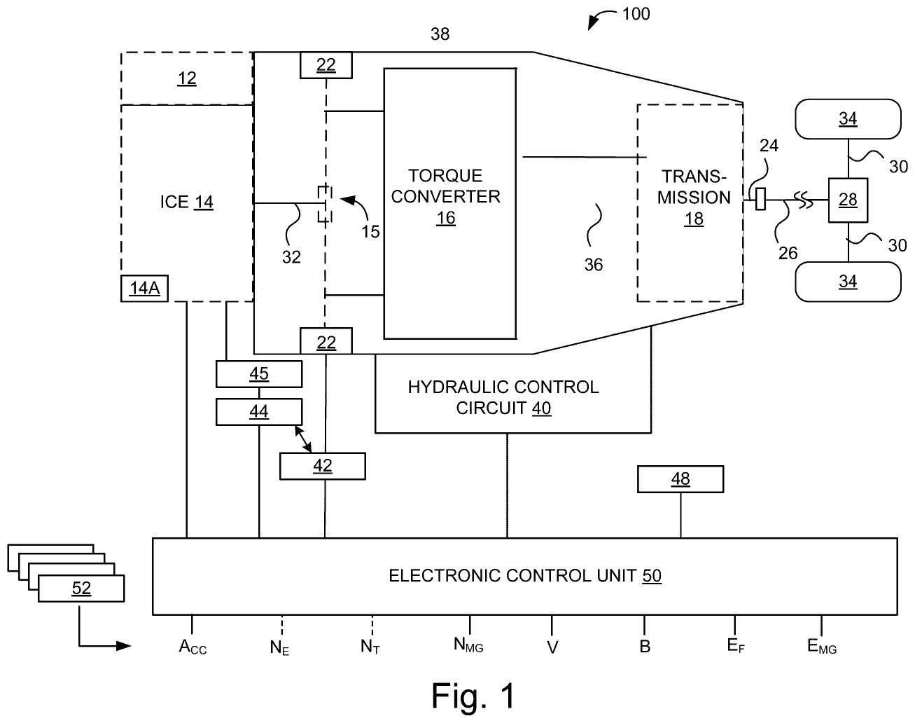

The systems and methods related to 3D transformation equivariance as disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example autonomous vehicle 100 in which embodiments of the disclosed technology may be implemented is illustrated in FIG. 1. Although the example described with reference to FIG. 1 is a type of autonomous vehicle, the systems and methods described herein can be implemented in other types of vehicles including semi-autonomous vehicles, vehicles with automatic controls (e.g., dynamic cruise control), or other vehicles. Also, the example vehicle 100 described with reference to FIG. 1 is a type of hybrid electric vehicle (HEV). However, this is not intended to be limiting, and the disclosed embodiments can be implemented in other types of vehicles including gasoline- or diesel-powered vehicles, fuel-cell vehicles, electric vehicles, or other vehicles.

According to an embodiment, vehicle 100 can be an autonomous vehicle implementing the 3D transformation equivariance system and functions, as disclosed herein. As used herein, “autonomous vehicle” means a vehicle that is configured to operate in an autonomous operational mode. “Autonomous operational mode” means that one or more computing systems of the vehicle 100 are used to navigate and/or maneuver the vehicle along a travel route with a level of input from a human driver which varies with the operational mode. As such, vehicle 100 can have a plurality of autonomous operational modes, where each mode correspondingly responds to a controller, for instance electronic control unit 50, with a varied level of automated response. In some embodiments, the vehicle 100 can have an unmonitored autonomous operational mode. “Unmonitored autonomous operational mode” means that one or more computing systems are used to maneuver the vehicle along a travel route fully autonomously, requiring no input or supervision required from a human driver. Thus, as an unmonitored autonomous vehicle 100, responses can be highly, or fully, automated. For example, a controller can be configured to communicate controls so as to operate the vehicle 100 autonomously and safely. After the controller communicates a control to the vehicle 100 operating as an autonomous vehicle, the vehicle 100 can automatically perform the desired adjustments (e.g., accelerating or decelerating) with no human driver interaction. Accordingly, vehicle 100 can operate any of the components shown in FIG. 1 autonomously, such as the engine 14.

Alternatively, or in addition to the above-described modes, vehicle 100 can have one or more semi-autonomous operational modes. “Semi-autonomous operational mode” means that a portion of the navigation and/or maneuvering of the vehicle 100 along a travel route is performed by one or more computing systems, and a portion of the navigation and/or maneuvering of the vehicle 100 along a travel route is performed by a human driver. One example of a semi-autonomous operational mode is when an adaptive cruise control system is activated. In such case, the speed of a vehicle 100 can be automatically adjusted to maintain a safe distance from a vehicle ahead based on data received from on-board sensors, but the vehicle 100 is otherwise operated manually by a human driver. Upon receiving a driver input to alter the speed of the vehicle (e.g., by depressing the brake pedal to reduce the speed of the vehicle), the speed of the vehicle is reduced. Thus, with vehicle 100 operating as a semi-autonomous vehicle, a response can be partially automated. In an example, the controller communicates a newly generated (or updated) control to the vehicle 100 operating as a semi-autonomous vehicle. The vehicle 100 can automatically perform some of the desired adjustments (e.g., accelerating) with no human driver interaction. Alternatively, the vehicle 100 may notify a driver that driver input is necessary or desired in response to a new (or updated) safety control. For instance, upon detecting a predicted trajectory that impacts safety, such as potential collision, vehicle 100 may reduce the speed to ensure that the driver is travelling cautiously. In response, vehicle 100 can present a notification in its dashboard display that reduced speed is recommended or required, because of the safety constraints. The notification allows time for the driver to press the brake pedal and decelerate the vehicle 100 to travel at a speed that is safe.

Additionally, FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 100 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 100 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 100 and is powered electrically via a battery 44. Battery 44 may be implemented as one or more batteries or other power storage devices including, for example, lead-acid batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, NT (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information. As will be described in further detail, the sensors 52 can be cameras (or other imaging devices) that are used to obtain image data, such as digital images and/or video. This image data from the sensors 52 can then be processed, for example by the electronic control unit 50, in order to implement the disclosed depth synthesis capabilities disclosed herein. Accordingly, the electronic control unit 50 can execute enhanced computer vision functions, such as depth extrapolation for future timesteps and predicting unseen viewpoints.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

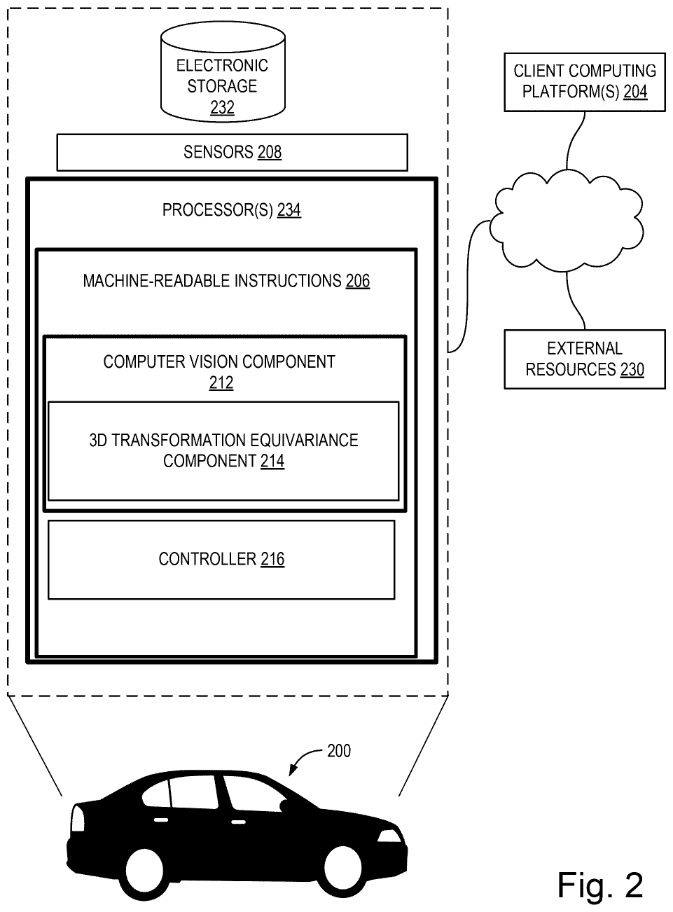

FIG. 2 illustrates a vehicle 200, for instance an autonomous vehicle, configured for implementing the disclosed 3D transformation equivariance system and functions. In particular, FIG. 2 depicts the vehicle 200 including a 3D transformation equivariance component 214. According to the disclose embodiments, the 3D transformation equivariance component 214 is configured to execute several enhanced computer vision capabilities, including: performing true equivariance to 3E(3) transformations without relying solely on data augmentation. For example, the component 214 is configured to implement Spherical Harmonics (e.g., replacing Fourier positional embedding), which ensures equivariance in 3D rotations for the input embeddings (e.g., from digital images and/or video).

In some implementations, vehicle 200 may also include sensors 208, electronic storage 232, processor(s) 234, and/or other components. Vehicle 200 may be configured to communicate with one or more client computing platforms 204 according to a client/server architecture and/or other architectures. In some implementations, users may access vehicle 200 via client computing platform(s) 204.

Sensors 208 may be configured to generate output signals conveying operational information regarding the vehicle. The operational information may include values of operational parameters of the vehicle. The operational parameters of vehicle 100 may include yaw rate, sideslip velocities, slip angles, percent slip, frictional forces, degree of steer, heading, trajectory, front slip angle corresponding to full tire saturation, rear slip angle corresponding to full tire saturation, maximum stable steering angle given speed/friction, gravitational constant, coefficient of friction between vehicle 200 tires and roadway, distance from center of gravity of vehicle 200 to front axle, distance from center of gravity of vehicle 200 to rear axle, total mass of vehicle 200, total longitudinal force, rear longitudinal force, front longitudinal force, total lateral force, rear lateral force, front lateral force, longitudinal speed, lateral speed, longitudinal acceleration, brake engagement, steering wheel position, time derivatives of steering wheel position, throttle, time derivatives of throttle, gear, exhaust, revolutions per minutes, mileage, emissions, and/or other operational parameters of vehicle 200. In some implementations, at least one of sensors 208 may be a vehicle system sensor included in an engine control module (ECM) system or an electronic control module (ECM) system of vehicle 200. In some implementations, at least one of sensors 208 may be vehicle system sensors separate from, whether or not in communication with, and ECM system of the vehicle. Combinations and derivations of information (or of parameters reflecting the information) are envisioned within the scope of this disclosure. For example, in some implementations, the current operational information may include yaw rate and/or its derivative for a particular user within vehicle 100.

In some implementations, sensors 208 may include, for example, one or more of an altimeter (e.g. a sonic altimeter, a radar altimeter, and/or other types of altimeters), a barometer, a magnetometer, a pressure sensor (e.g. a static pressure sensor, a dynamic pressure sensor, a pitot sensor, etc.), a thermometer, an accelerometer, a gyroscope, an inertial measurement sensor, a proximity sensor, global positioning system (or other positional) sensor, a tilt sensor, a motion sensor, a vibration sensor, an image sensor, a camera, a depth sensor, a distancing sensor, an ultrasonic sensor, an infrared sensor, a light sensor, a microphone, an air speed sensor, a ground speed sensor, an altitude sensor, medical sensor (including a blood pressure sensor, pulse oximeter, heart rate sensor, driver alertness sensor, ECG sensor, etc.), degree-of-freedom sensor (e.g. 6-DOF and/or 9-DOF sensors), a compass, and/or other sensors. As used herein, the term “sensor” may include one or more sensors configured to generate output conveying information related to position, location, distance, motion, movement, acceleration, and/or other motion-based parameters. Output signals generated by individual sensors (and/or information based thereon) may be stored and/or transferred in electronic files. In some implementations, output signals generated by individual sensors (and/or information based thereon) may be streamed to one or more other components of vehicle 200. In some implementations, sensors may also include sensors within nearby vehicles (e.g., communicating with the subject vehicle via V to V or other communication interface) and or infrastructure sensors (e.g., communicating with the subject vehicle via the V2I or other communication interface).

Sensors 208 may be configured to generate output signals conveying visual and/or contextual information. The contextual information may characterize a contextual environment surrounding the vehicle. The contextual environment may be defined by parameter values for one or more contextual parameters. The contextual parameters may include one or more characteristics of a fixed or moving obstacle (e.g., size, relative position, motion, object class (e.g., car, bike, pedestrian, etc.), number of lanes on the roadway, direction of traffic in adjacent lanes, relevant traffic signs and signals, one or more characteristics of the vehicle (e.g., size, relative position, motion, object class (e.g., car, bike, pedestrian, etc.)), direction of travel of the vehicle, lane position of the vehicle on the roadway, time of day, ambient conditions, topography of the roadway, obstacles in the roadway, and/or others. The roadway may include a city road, urban road, highway, onramp, and/or offramp. The roadway may also include surface type such as blacktop, concrete, dirt, gravel, mud, etc., or surface conditions such as wet, icy, slick, dry, etc. Lane position of a vehicle on a roadway, by way of example, may be that the vehicle is in the far-left lane of a four-lane highway, or that the vehicle is straddling two lanes. The topography may include changes in elevation and/or grade of the roadway. Obstacles may include one or more of other vehicles, pedestrians, bicyclists, motorcyclists, a tire shred from a previous vehicle accident, and/or other obstacles that a vehicle may need to avoid. Traffic conditions may include slowed speed of a roadway, increased speed of a roadway, decrease in number of lanes of a roadway, increase in number of lanes of a roadway, increase volume of vehicles on a roadway, and/or others. Ambient conditions may include external temperature, rain, hail, snow, fog, and/or other naturally occurring conditions.

In some implementations, sensors 208 may include virtual sensors, imaging sensors, depth sensors, cameras, and/or other sensors. As used herein, the term “camera”, “sensor” and/or “image sensor” and/or “imaging device” may include any device that captures images, including but not limited to a single lens-based camera, a calibrated camera, a camera array, a solid-state camera, a mechanical camera, a digital camera, an image sensor, a depth sensor, a remote sensor, a lidar, an infrared sensor, a (monochrome) complementary metal-oxide-semiconductor (CMOS) sensor, an active pixel sensor, and/or other sensors. Individual sensors may be configured to capture information, including but not limited to visual information, video information, audio information, geolocation information, orientation and/or motion information, depth information, and/or other information. The visual information captured by sensors 208 can be in the form of digital images and/or video that includes red, green, blue (RGB) color values representing the image. Information captured by one or more sensors may be marked, timestamped, annotated, and/or otherwise processed such that information captured by other sensors can be synchronized, aligned, annotated, and/or otherwise associated therewith. For example, contextual information captured by an image sensor may be synchronized with information captured by an accelerometer or other sensor. Output signals generated by individual image sensors (and/or information based thereon) may be stored and/or transferred in electronic files.

In some implementations, an image sensor may be integrated with electronic storage, e.g., electronic storage 232, such that captured information may be stored, at least initially, in the integrated embedded storage of a particular vehicle, e.g., vehicle 200. In some implementations, one or more components carried by an individual vehicle may include one or more cameras. For example, a camera may include one or more image sensors and electronic storage media. In some implementations, an image sensor may be configured to transfer captured information to one or more components of the system, including but not limited to remote electronic storage media, e.g. through “the cloud.”

Vehicle 200 may be configured by machine-readable instructions 206. Machine-readable instructions 206 may include one or more instruction components. The instruction components may include computer program components. The instruction components may include one or more of: a computer vision component 212; a GSR component 214; a controller 216, and/or other instruction components.

As a general description, the illustrated components within the machine-readable instructions 206 include the computer vision component 212 and the 3D transformation equivariance component 214. As previously described, the 3D transformation equivariance component 214 is configured to execute several enhanced computer vision capabilities, including: performing true equivariance to 3E(3) transformations without relying solely on data augmentation; implementing Spherical Harmonics (e.g., replacing Fourier positional embedding), which ensures equivariance in 3D rotations for the input embeddings (e.g., from digital images and/or video).

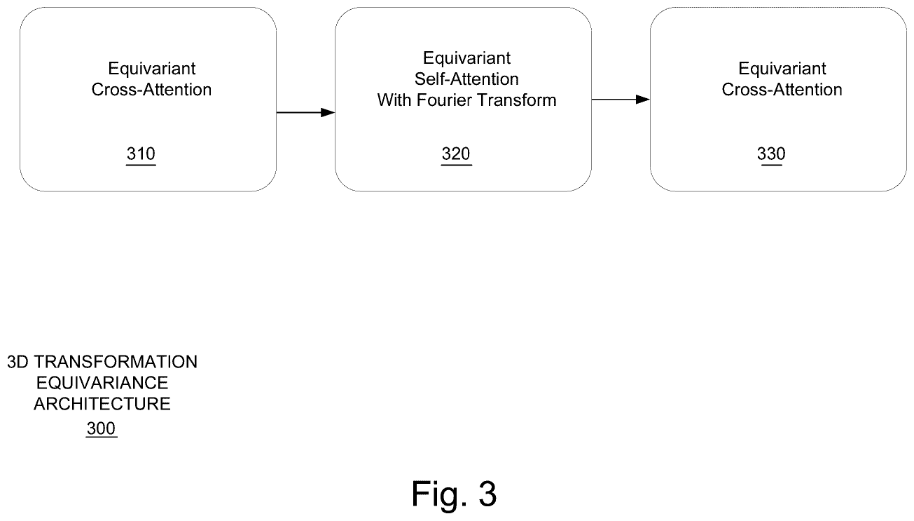

FIG. 2 also shows that the machine-readable instructions 206 includes a computer vision component 212, which is configured to perform the larger breadth of computer vision functions, such as object detection, which can drive the various autonomous vision and controls utilized by autonomous vehicles. The computer vision component 212 can also be described as implementing the disclosed equivariance in 3D rotations capabilities vis-à-vis the 3D transformation equivariance component 214 (the 3D transformation equivariance component 214 is an element of the computer vision component 212). As an example, the computer vision component 212 can implement object detection (in combination with advanced cameras and sensors), enabling the vehicle 200 to analyze its surroundings and respond with autonomous vehicle controls. Further, as an example, the 3D transformation equivariance component 214 allows the vehicle 200 to leverage equivariance in 3D rotations to perform depth estimation and/or scene representation capabilities (e.g., enhanced computer vision functions), such as creating dense depth maps that complete unseen portions of a scene. Accordingly, the computer vision component 212 and the 3D transformation equivariance component 214 can function in concert with the other components of the vehicle 200, such as sensors 208 (e.g., camera), in order to support vision AI and enhanced computer vision capabilities that can be employed during the autonomous operation of vehicle 200. Example architectures for the 3D transformation equivariance component 214 are depicted in FIG. 3-FIG. 5. As a general description, each of the architectures for the 3D transformation equivariance component 214 comprise three main components: equivariant cross-attention, equivariant self-attention, and equivariant cross-attention after self-attention. As will be described in greater detail herein, 3D transformation equivariance component 214 can be implemented using three distinct architectures, each differing in certain aspects of these components. The associated structure and function of the elements within the 3D transformation equivariance component's 214 architecture are discussed in greater detail in reference to FIG. 3-FIG. 5.

Now referring to FIG. 3, an example architecture 300 for the abovementioned 3D transformation equivariance component is depicted. In the equivariant 3D transformation equivariance component 300, the hidden features are composed of different orders (types) of features in the format as (H₀, H₁, . . . Hₗₘₐₓ), where the subscripts denote the type of the feature, the size for each type of feature Hₗ is in the format (2l+1, . . . , Cₗ), where 2l+1 is the intrinsic dimension for type-l feature and Cₗ is the number of channels of the type-l feature. When it is transformed with a rotation R, the hidden features transform can be represented mathematically as follows:

$$( {H}_{0 ,} , {H}_{1} … , {H}_{lmax} ) \to ( {H}_{0} , {D}^{1} ( R ) {H}_{1} , … {D}^{lmax} ( R ) {H}_{lmax} ) \qquad ( 1 )$$

where D^{l} are the Winger-D matrices.

The linear layer [symbol] is equivariant when it is represented mathematically as follows:

$$ℒ ( ( {H}_{0}^{( k )} , {D}^{1} ( R ) {H}_{1}^{( k )} … {D}_{lmax} ( R ) {H}_{lmax}^{( k )} ) ) = ( {H}_{0}^{( k + 1 )} , {D}^{1} ( R ) {H}_{1}^{( k + 1 )} … {D}_{lmax} ( R ) {H}_{lmax}^{( k + 1 )} ) \qquad ( 1 )$$

The Linear Layer [symbol] takes in as input a tuple of hidden states (H₀^{(k)}, H₁^{(k)}, . . . Hₗₘₐₓ^{(k)}) from layer k, where lₘₐₓ represents the maximum order. The output of the linear layer [symbol] at the next layer, denoted by k+1 consists of the corresponding hidden states (H₀^{(k+1)}, H₁^{(k+1)}, . . . Hₗₘₐₓ^{(k+1)}).

In simpler terms, the linear layer preserves equivariance by maintaining the relationships between the hidden stats across different orders, while also accounting for any 3D rotation represented by the Wigner-D matrices D¹(R), D²(R), . . . , D^{lmax}(R). This property ensures that the network retains its equivariant behavior under spatial transformations as it processes the hidden states through subsequent layers.

In order to achieve this equivariance, the linear layer [symbol] can be designed such that it is represented mathematically as:

$$ℒ ( ( {H}_{0}^{( k )} , {H}_{1}^{( k )} … {H}_{lmax}^{( k )} ) ) = ( {H}_{0}^{( k + 1 )} {W}_{0} , {H}_{1}^{( k + 1 )} {W}_{1} … {H}_{lmax}^{( k + 1 )} {W}_{lmax} ) ) \qquad ( 3 )$$

The weights Wₗ have the format (Cₗ^{(k)}, Cₗ^{(k+1)}), where Cₗ^{(k)} is the number of channels in Hₗ^{(k)}, representing the corresponding output channels. By applying this linear transformation independently to each hidden state while taking into account the specific number of input and output channels, it is ensured that the network maintains its equivariant behavior under spatial transformations throughout the learning process.

There are several options of equivariant nonlinear layers. In an option, the nonlinear layer A can be represented mathematically as:

$$A ( ( {H}_{0}^{( k )} , {H}_{1}^{( k )} , … {H}_{lmax}^{( k )} ) ) = ( a ( {H}_{0}^{( k )} ) , a ( n o r m ( {H}_{1}^{( k )} ) + {β}_{1} ) \cdot \frac{{H}_{1}^{( k )}}{n o r m ( {H}_{1}^{( k )} )} , … , ( norm ( {H}_{1}^{( k )} ) + {β}_{1} ) \cdot \frac{{H}_{lmax}^{( k )}}{n o r m ( {H}_{lmax}^{( k )} )} \qquad ( 4 )$$

where norm is to get norm of the feature Hₗ^{(k)} across the first dimension.

The size of norm Hₗ^{(k)} is in the format (1, . . . Cₗ), βₗ is the learning bias, whose size is in the format (1, . . . Cₗ), a is the conventional activation operation, such as ReLU, Sigmoid, and LeakyReLu and operator “·” is the broadcast multiplication.

Another way to represent the nonlinear format is the GATE nonlinearity, which is also similar to the nonlinearity in the vector neuron. The intermediate hidden features (\acute{H}₁^{(k)}, . . . \acute{H}ₗₘₐₓ^{(k)}) with the same size as the input can be derived, though an equivariant linear layer which can then be represented mathematically as:

$$A ( ( {H}_{0}^{( k )} , {H}_{1}^{( k )} , … {H}_{lmax}^{( k )} ) ) = ( a ( {H}_{0}^{( k )} ) , a ( ( {H}_{1}^{( k )} , {{H}^{'}}_{1}^{( k )} ) ) - ( {H}_{1}^{( k )} , {{H}^{'}}_{1}^{( k )} ) ) \cdot \frac{{{H}^{'}}_{1}^{( k )}}{n o rm ( {{H}^{'}}_{1}^{( k )} )} + {H}_{1}^{( k )} , … , ( a ( ( {H}_{lmax}^{( k )} , {{H}^{'}}_{lmax}^{( k )} ) ) - ( {H}_{lmax}^{( k )} , {{H}^{'}}_{lmax}^{( k )} ) ) \cdot \frac{{{H}^{'}}_{lmax}^{( k )}}{n o rm ( {{H}^{'}}_{lmax}^{( k )} )} + {H}_{lmax}^{( k )} ) \qquad ( 5 )$$

where [symbol] ·,· [symbol] is per channel inner product

That is, the size of [symbol] Hₗ^{(k)}, \acute{H}ₗ^{(k)} [symbol] is in the format (1, . . . Cₗ). There is a third representation, which includes treating the feature (\acute{H}₁^{(k)}, . . . , \acute{H}ₗₘₐₓ^{(k)}) as the Fourier coefficients of the Spherical functions. The inverse Fourier transform is first applied, then the conventional application layer is applied to the obtained spherical signals.

There is also an equivariant layer normalization layer. Normalization to the norm of the features in the equivariant layer normalization layer can be applied in a manner that is similar to the equivariant nonlinear layer as previously described. The normalization layer LN (of the equivariant layer normalization layer) can be represented mathematically as:

$$ℒ𝒩 ( ( {H}_{0}^{( k )} , {H}_{1}^{( k )} … {H}_{lmax}^{( k )} ) ) = ( ln ( {H}_{0}^{( k + 1 )} , ln ( n o r m ( {H}_{1}^{( k )} ) ) \cdot \frac{{H}_{1}^{( k )}}{n orm ( {H}_{1}^{( k )} )} , … , ln ( n o r m ( {H}_{1}^{( k )} ) ) \cdot \frac{{H}_{lmax}^{( k )}}{n orm ( {H}_{lmax}^{( k )} )} ) \qquad ( 6 )$$

where ln is the conventional layer normalization.

Specifically, FIG. 3 illustrates that a first configuration option for the framework for the 3D transformation equivariance architecture 300, which is referred to herein as an equivariant cross-attention configuration. As shown in FIG. 3, the 3D transformation equivariance architecture 300 includes several elements and embeddings used to encode and decode information for translation of rotational transformations. In the example of FIG. 3, the equivariant cross-attention configuration for the 3D transformation equivariance architecture 300 includes: Equivariant Cross-Attention module 310, Equivariant Self-Attention with Fourier Transform module 320; and Equivariant Cross-Attention module 330.

As a general description, of the equivariant cross-attention configuration for the 3D transformation equivariance architecture 300, the conventional Fourier positional encoding are replaced with spherical harmonics. For example, the Equivariant Cross-Attention module 310 implements spherical harmonics for the input ray vectors and the translation of the cameras can be represented mathematically as:

$$P E ( {r}_{j}^{i} ) = ( {Y}^{1} ( {r}_{j}^{i} ) , {Y}^{2} ( {r}_{j}^{i} ) , … , {Y}^{lmax} ( {r}_{j}^{i} ) ) \qquad ( 7 )$$

$$PE ( {T}^{i} ) = ( {Y}^{1} ( {T}^{1} - \overline{T} ) , {Y}^{2} ( {T}^{1} - \overline{T} ) , … , {Y}^{lmax} ( {T}^{1} - \overline{T} ) ) \qquad ( 8 )$$

where rⱼⁱ is the j-th ray of the i-th camera,
T¹ is the translation of the i-th camera, and
T̅ is the center of the input of multiple cameras as

$$\overline{T} = \frac{1}{N} {\sum }_{i}^{N} {T}^{i}$$

In order to achieve translation equivariance, the center of the translations T are subtracted from each camera's translation. By doing so, the attention layers only need to achieve rotation equivariance to ensure SE(3) equivariance. This approach simplifies the task of attention layers, as they now only need to focus on maintaining rotational invariance, while the translation equivariance is already handled by the subtraction of the common translation center T̅. This design choice helps to achieve overall SE(3) equivariance for the entire system.

To sum up, the input to the transformer is the latent code [symbol] _{c} and the features in the format as (fⱼⁱ,PE(rⱼⁱ), PE(Tⁱ)) where fⱼⁱ is attached image feature for each ray. Thus, it can be verified that:

$$( {f}_{j}^{i} , PE ( R {r}_{j}^{i} ) , PE ( R {T}^{i} ) ) = ( {f}_{j}^{i} R \cdot PE ( {r}_{j}^{i} ) , R \cdot PE ( {T}^{i} ) ) , where \qquad ( 9 )$$

$$R \cdot PE ( {r}_{j}^{i} ) = ( {D}^{1} ( R ) {Y}^{1} ( {r}_{j}^{i} ) , {D}^{2} ( R ) {Y}^{2} ( {r}_{j}^{i} ) , … , {D}^{lmax} , ( R ) {Y}^{lmax} ( {r}_{j}^{i} ) ) and \qquad ( 10 )$$

$$R \cdot PE ( {T}^{i} ) = ( {D}^{1} ( R ) {Y}^{1} ( {T}^{i} - \overline{T} ) , {D}^{2} ( R ) {Y}^{2} ( {T}^{i} - \overline{T} ) , … , {D}^{lmax} ( R ) {Y}^{lmax} ( {T}^{i} - \overline{T} ) \qquad ( 11 )$$

$$which means$$

$$( {f}_{j}^{i} , ( PE ( R {r}_{j}^{i} ) , PE ( R {T}^{i} ) ) = ( {f}_{j}^{i} , R \cdot PE ( {T}^{i} ) ) \qquad ( 12 )$$

That is, eq. (12) is also the composition of different types of features, and it can be expressed in the format (H₀, Hₗ, . . . Hₗₘₐₓ) with Cₗ=2 for l≤1 and C₀ is the channel number of fⱼⁱ. The query in the transformer can be generated mathematically as:

$${f}_{q} = {R}_{c} {W}_{q} \qquad ( 13 )$$

With the size in the format (N_{R},C), the key in the transformer are only generated by the image feature fⱼⁱ, and represented mathematically as:

$${( {f}_{j}^{i} )}_{k} = {f}_{j}^{i} {W}_{k} \qquad ( 14 )$$

where the size in the format B, N, C

The value in the transformer is generated by the concatenated feature (fⱼⁱ,PE(rⱼⁱ),PE(Tⁱ)) through an equivariant linear layer, which can be represented mathematically as:

$${( {f}_{j}^{i} )}_{v} = {ℒ}_{v} ( {f}_{j}^{i} ) ) ; \qquad ( 15 )$$

$${D}^{lmax} ( R ) \qquad ( 16 )$$

$$PE ( x + t ) = \to ⌊ \begin{matrix}cos ( ω t ) & - sin ( ω t ) \\ sin ( ω t ) & cos ( ω t )\end{matrix} ⌋ ⌊ \begin{matrix}cos ( ω x ) & - sin ( ω x ) \\ sin ( ω x ) & cos ( ω x )\end{matrix} ⌋ \qquad ( 17 )$$

The eq. (15)-(17) can result in different types of features. The size for each type of feature is represented as (2l+1, B, N, Cₗ), where Cₗ is the channel size for a specific order l. For convenience, (fⱼⁱ)v as ((V₀)ⱼⁱ, (V₁)ⱼⁱ, . . . (Vₗₘₐₓ)ⱼⁱ), since the value should be a composition of the different types of features, which can be represented mathematically as:

$$( {( {H}_{0} )}_{j}^{i} , {( {H}_{1} )}_{j}^{i} , … , {( {H}_{lmax} )}_{j}^{i} \qquad ( 18 )$$

The inner product in the attention occurs between the query f_{q} and fₖ to obtain the attention weights, with size (B, N_{R}, N) or (B, N_{R}, H, N) for multi-head mechanisms. In this implementation, the multi-head attention mechanism is used, and the multi-head number is H+NL, where NL is number of non-zero types of features. The attention weights with size (B, N_{R}, H+NL, N) are split into attention weights A₂ with size (B, N_{R}, NL, N). The first attention part, A₁, is used to generate the zero-type order feature, which can be represented mathematically as:

$${H}_{0}^{out} = softmax ( {A}_{1} ) {V}_{0} ) , \qquad ( 19 )$$

where V₀ has the size

$$( B , {N}_{R} , H , \frac{{C}_{0}}{H} ) ,$$

therefore the size of H₀^{out} is (B, N_{R}, C₀).

For the non-zero type features, each type of feature can be represented mathematically as:

$${H}_{l}^{out} = soft {max ( {A}_{2} )}_{t} ) {V}_{l} \qquad ( 20 )$$

where (A₂)ₗ=A[:,:,0,:], Vₗ has the size (2l+1, B, N, Cₗ) and the output Hₗ^{out} has the size 2l+1, B, N_{R}, Cₗ)

The ultimate output of the equivariant cross-attention module 310 would be represented as (H₀^{out}, Hₗ^{out}, . . . , Hₗₘₐₓ^{out}) which then passes through the equivariant layernorm layer and the equivariant MLP. The equivariant MLP consist of a combination of equivariant linear layers and equivariant nonlinear layers.

The equivariant cross-attention module 310 outputs hidden features in the format (H₀^{out}, Hₗ^{out}, . . . , Hₗₘₐₓ^{out}) which serves as the input to the equivariant self-attention with Fourier Transform module 320. The query, key and value are obtained through the equivariant linear layer. When it comes to the attention where the key, query and value, to entangle different types of features, the most straightforward method is to apply the tensor product to the key and query, which is complicated and computationally expensive. However, there is an alternative approach that treats the different types of features as Fourier coefficients to obtain spherical features. By applying the conventional transformer to these spherical features, followed by the Fourier Transform, we can retrieve the different types of equivariant features. This method offers a more efficient way to entangle and handle various types of features within the attention mechanism. The equivariant self-attention with Fourier Transform module 320 applies Inverse Fourier Transform to the input feature in such way that can be represented mathematically as:

$${S}_{l} ( x ) = {{Y}^{l} ( x )}^{T} {H}_{l} \qquad ( 21 )$$

This implies that the S^{l} has the (B, N_{R}, C_{L}, N_{S}), where N_{S} is the sampling for the sphere. From the preliminary, it is known that the when the input features rotate by a rotation R the output becomes Sₗ(R⁻¹x) which means that the sphere are rotated as well. By concatenating the {Sₗ} the feature can be obtained after the inverse Fourier Transform with size (B, N_{R}, Σₗ C_{L}, N_{S}). Afterwards there are (B, N_{R}, Σₗ C_{L}) spheres, and the equivariant self-attention with Fourier Transform module 320 can apply the conventional self-attention to these spheres without breaking equivariance, resulting in the spherical feature F with dimensions (B, N_{R}, Σₗ C_{L}, N_{S}) after the self-attention. Thereafter, the equivariant self-attention with Fourier Transform module 320 applies the Fourier Transform, which can be represented mathematically as:

$${H}_{l} = {\sum }_{i} {{S}^{l} ( x )}_{i} {Y}^{l} ( {x}_{i} ) \qquad ( 22 )$$

where S^{l}(x)ₗ=F[:,:,Ind_{Cl}i], and Ind_{Cl} represents the index of channels for spheres that correspond to the type-l feature.

This gives Hₗ with dimensions (B, N_{R}, C_{L}, 2l+1). In the implementation, it may be needed to transpose the dimensions to obtain the final feature Hₗ with dimensions (2ₗ+1, B, N_{R}, Cₗ). By composing different types of features, the output feature can be obtained in the format (H₀, H₁ . . . Hₗₘₐₓ) from the equivariant self-attention with Fourier Transform module 320. It is evident that the composition of inverse Fourier Transform, conventional transformer on the sphere and the Fourier Transform is equivariant, as confirmed by the preliminary properties of the Fourier Transform.

The equivariant cross-attention module 330 is configured to receive two inputs: the hidden features of the self-attention which are represented as (H₀, H₁ . . . Hₗₘₐₓ); and the encoding of the query rays and cameras, which are given as (PE(rⱼⁱ), PE(Tⁱ−T̅ⁱ). Here rⱼⁱ denotes the j-th ray in the i-th camera, Tⁱ is the translation of the i-th camera, and T̅ is the center of the encoded cameras, which was previously calculated. As previously described, the encoding as the format (H₀, H₁ . . . Hₗₘₐₓ).

To obtain the key K and the value V in the transformer, the equivariant linear layer is applied to the hidden feature R. Consequently, K and V are composed of different types of features, and they can be denoted as (K₁, . . . Kₗₘₐₓ), where Kₗ has the size (2ₗ+1, B, N_{R}, Cₗ^{k}), and (V₀, V₁ . . . Vₗₘₐₓ), where Vₗ has the size (2ₗ+1, B, N_{R}, Cₗ^{v}).

The query Q in the transformer is obtained by applying the equivariant linear layer, resulting in the format (Q₁, . . . Qₗₘₐₓ), where Q has the size (2ₗ+1, B, N_{R}, Cₗ^{k}). The inner product occurs between the key (K₁, . . . Kₗₘₐₓ) and the query (Q₁, Q₂ . . . Qₗₘₐₓ). The output feature for the non-zero can be obtained in a manner that is represented mathematically as:

$${H}_{l}^{out} = soft max ( 〈 {Q}_{l} , {K}_{l} 〉 ) {V}_{l} \qquad ( 23 )$$

where [symbol] .,. [symbol] represents the inner product

To perform the inner product, Qₗ is flattened to the feature

$$( 2 l + 1 , B , {N}_{R} , H , \frac{{C}_{l}^{k}}{H} )$$

and then transposed to

$$( B , {N}_{R} , H , \frac{{C}_{l}^{k}}{H} , 2 l + 1 )$$

and then finally reshaped to

$$( B , {N}_{R} , H , \frac{{C}_{l}^{k}}{H} \times ( 2 l + 1 ) ) .$$

Therefore, [symbol] Qₗ, Kₗ [symbol] results in the attention weights with dimensions (B, N, N_{R}, H). Vₗ can be reshaped to the feature with dimensions

$$( 2 l + 1 , B , N , H , \frac{{C}_{l}^{v}}{H} )$$

and we finally obtain the output feature Hₗ^{out} with size (2l+1, B, N, H, Ćₗ^{v}) from the equivariant cross-attention module 330.

For the zero-type output feature, another key \acute{K}=(\acute{K}1, \acute{K}2, . . . , \acute{K}l\acute{m}ax) and query \acute{Q}=(\acute{Q}1, \acute{Q}2, . . . , Ól\acute{m}ax) where \acute{K}ₗ has the size of (2l+1, B, N_{R}, Ćₗ^{k}) and \acute{Q}ₗ has the size of (2l+1, B, N_{R}, Ćₗ^{q}).

For a multiheaded mechanism, each type of feature \acute{K}ₗ can be transposed to (B, N_{R}, Ćₗ^{q}, 2l+1) and then reshaped to

$$( B , {N}_{R} , H , \frac{{C}_{l}^{q}}{H} \times ( 2 l + 1 ) ) .$$

Similarly, \acute{Q}ₗ can be transformed to a feature with a size of

$$( B , {N}_{R} , H , \frac{{C}_{l}^{q}}{H} \times ( 2 l + 1 ) ) .$$

We concatenate the different type of features to obtain the new \acute{K} with size of

$$( B , {N}_{R} , H , {\sum }_{L} \frac{{C}_{l}^{q}}{H} \times ( 2 l + 1 ) )$$

and new \acute{Q} with size of

$$( B , {N}_{R} , H , {\sum }_{L} \frac{{C}_{l}^{q}}{H} \times ( 2 l + 1 ) ) .$$

The invariant attention weight A can be derived by applying the inner product of the new \acute{K} and \acute{Q}, which results in the size A as (B, N, H, N_{R}). The type-0 feature can then be obtained from the equivariant cross-attention module 330 in the manner that can be represented mathematically as:

$${H}_{0}^{out} = soft max ( A ) {V}_{0} \qquad ( 24 )$$

where V₀ has the size

$$( B , {N}_{R} , H , \frac{{C}_{0}^{v}}{H} )$$

and H₀^{out} has the size (B, N, C₀^{v})

The zero types of features and the non-zero types of features are composed to obtain the output equivariant feature from the equivariant cross-attention module 330 in the format (H₀^{out}, H₁^{out}, . . . Hₗₘₐₓ^{out}). In order to get the invariant feature, an immediate feature \acute{H} can be first obtained with the same size as H^{out} through an equivariant layer, and for each type, the inner product is applied to \acute{H}ₗ and Hₗ^{out} to get an invariant feature Iₗ with size (B, N, Cₗ^{v}). Concatenate {Iₗ} to derive the final invariant feature I with size (B, N, Σₗ Cₗ^{v}) which is output from the 3D transformation equivariance architecture 300 and leveraged for the final prediction.

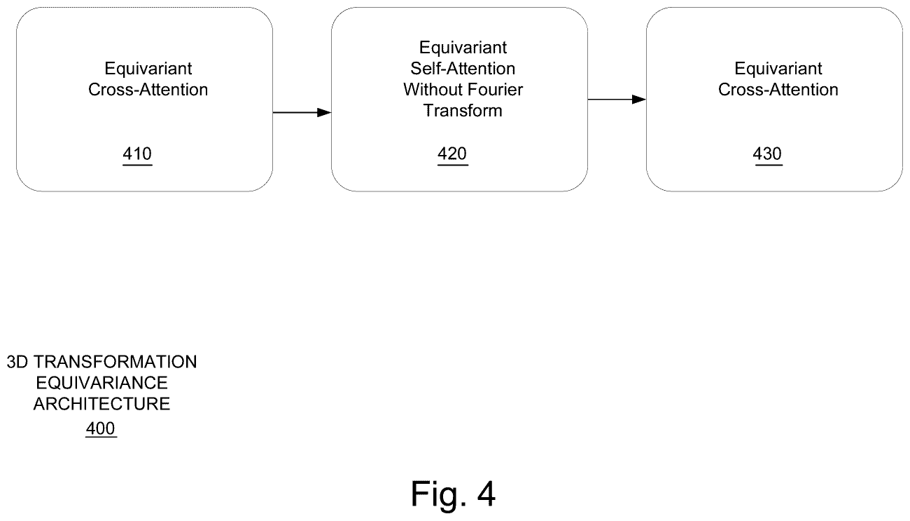

FIG. 4 depicts another example configuration for the 3D transformation equivariance architecture 400, as disclosed herein. The previously discussed equivariant cross-attention configuration (shown in FIG. 3) for the 3D transformation equivariance architecture can experience equivariance that is broken by the sampling process in the Fourier Transform. Accordingly, to mitigate this issue, the configuration for the 3D transformation equivariance architecture 400 illustrated in FIG. 4 includes a distinct equivariant self-attention module without Fourier Transform 420 that is a modification from the equivariant self-attention module utilized in the previous configuration of FIG. 3. That is, by eliminating the Fourier Transformation (and thus the sampling), the configuration for the 3D transformation equivariance architecture 400, also referred to herein as an equivariant cross-attention with Fourier configuration, achieves a more efficient self-attention.

As shown in FIG. 4, the 3D transformation equivariance architecture 400 includes several elements and embeddings used to encode and decode information for translation of rotational transformations. In the example of FIG. 4, the equivariant cross-attention configuration for the 3D transformation equivariance architecture 400 includes: Equivariant Cross-Attention module 410, Equivariant Self-Attention without Fourier Transform module 420; and Equivariant Cross-Attention module 430.

The Cross-Attention module 410 has a function and structure that is substantially similar to the Cross-Attention module 310 previously described in reference to FIG. 3. According, for purposes of brevity, the details of the Cross-Attention module 410 are not described in detail again here in reference to FIG. 4.

The input into the equivariant self-attention without Fourier Transform module 420 is the output of the equivariant cross-attention module 410, which has the format (H^{out}O, H^{out}1, . . . H^{out}lmax). To obtain the key K, query Q, and value V three equivariant linear layers are utilized.

Since key K, query Q, and value V are all composed of different types of features, we denote K=(K₀, K₁, . . . , Kₗₘₐₓ), where Kₗ has the size (2l+1, B, N_{R}, Cₗ^{k}); Q=(Q₀, Q₁, . . . , Qₗₘₐₓ), where Qₗ has the size (2l+1, B, N_{R}, Cₗ^{q}); and V=(V₀, V₁, . . . , Vₗₘₐₓ), where Qₗ has the size (2l+1, B, N_{R}, Cₗ^{v}). For a multi-headed mechanism, Kₗ can be reshaped as a feature with size

$$( 2 l + 1 , B , {N}_{R} , H , \frac{{C}_{l}^{k}}{H} ) ;$$

Qₗ can be reshaped as a feature with size

$$( 2 l + 1 , B , {N}_{R} , H , \frac{{C}_{l}^{q}}{H} ) ;$$

and Vₗ can be reshaped as a feature with size

$$( 2 l + 1 , B , {N}_{R} , H , \frac{{C}_{l}^{v}}{H} ) .$$

Next, the equivariant self-attention without Fourier Transform module 420 transposes Kₗ to a feature with the size

$$( B , {N}_{R} , H , \frac{{C}_{l}^{k}}{H} , 2 l + 1 )$$

and flattens it to obtain the feature \acute{K}ₗ with size

$$( B , {N}_{R} , H , \frac{{C}_{l}^{k}}{H} ( 2 l + 1 ) ) .$$

Similar options are applied to Qₗ to get the new feature \acute{Q}ₗ with the size

$$( B , {N}_{R} , H , \frac{{C}_{l}^{q}}{H} ( 2 l + 1 ) )$$

and Vₗ to get the new feature \acute{V}ₗ with the size

$$( B , {N}_{R} , H , \frac{{C}_{l}^{v}}{H} ( 2 l + 1 ) ) .$$

The equivariant self-attention without Fourier Transform module 420 is then configured to concatenate the different types of features and obtain new features, including: \acute{K} with size

$$( B , {N}_{R} , H , {\sum }_{L} \frac{{C}_{l}^{k}}{H} ( 2 l + 1 ) ) ,$$

\acute{Q} with size

$$( B , {N}_{R} , H , {\sum }_{L} \frac{{C}_{l}^{q}}{H} ( 2 l + 1 ) ) ,$$

and \acute{V} with size

$$( B , {N}_{R} , H , {\sum }_{L} \frac{{C}_{l}^{v}}{H} ( 2 l + 1 ) ) .$$

The invariant attention weight can be derived by applying the inner product to \acute{K} and Q and obtain the attention weight matrix A with size (B, N_{R}, H, N_{R}). The output from the equivariant self-attention without Fourier Transform module 420 is derived in a manner that can represented mathematically as:

$${H}^{out} = soft max ( A ) {V}^{′} \qquad ( 25 )$$

This implies that the size of the feature H^{out} is

$$( B , {N}_{R} , H ( {\sum }_{V} \frac{{C}_{l}^{v}}{H} ( 2 l + 1 ) ) ) .$$

if we reshape the H^{out} as the feature with the size

$$( B , {N}_{R} , ( {\sum }_{V} \frac{{C}_{l}^{v}}{H} ( 2 l + 1 ) ) ,$$

we can easily validate the feature for each head with the size

$$( B , {N}_{R} , ( {\sum }_{V} \frac{{C}_{l}^{v}}{H} ( 2 l + 1 ) )$$

is the composition of different types of features and each head can be represented in the format (H₀, H₁, . . . , Hₗₘₐₓ) and Hₗ has the size

$$( 2 l + 1 , B , {N}_{R} , \frac{{C}_{v}^{v}}{H} ) .$$

Therefore, the whole feature H^{out} is also the feature composed of different types of features, which can be reshaped to the feature \acute{H}^{out} in the format (H₀, H₁, . . . , Hₗₘₐₓ) and Hₗ has the size (2l+1, B, N_{R}, Cₗ^{v}). The final output feature from the equivariant self-attention without Fourier Transform module 420 is \acute{H}^{out}.

The Equivariant Cross-Attention module 430 (after self-attention) has a function and structure that is substantially similar to the Cross-Attention module 330 previously described in reference to FIG. 3. According, for purposes of brevity, the details of the Cross-Attention module 430 are not described in detail again here in reference to FIG. 4.

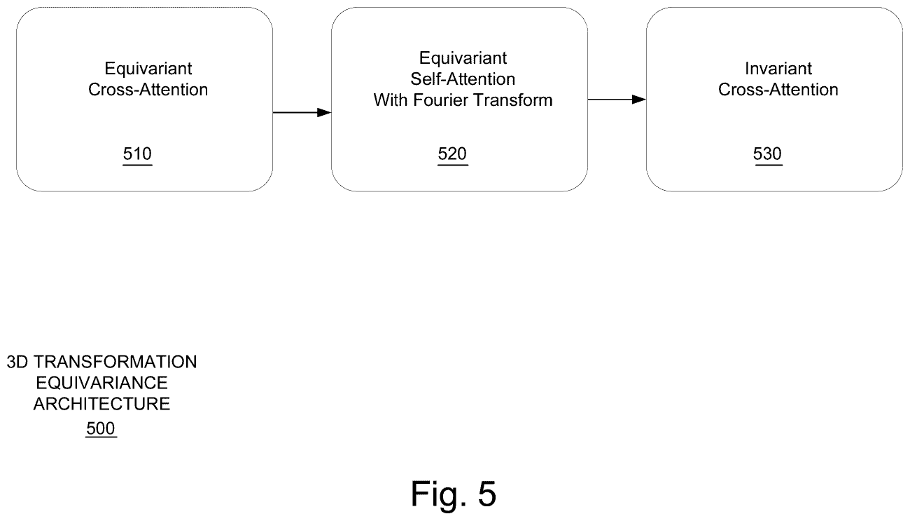

FIG. 5 depicts yet another example configuration for the 3D transformation equivariance architecture 500, as disclosed herein. The previously discussed configurations (shown in FIG. 3 and FIG. 4) for the 3D transformation equivariance architecture can experience and inability to capture higher frequency information in the decoder embedding, which can potentially limit the overall power of the network. Accordingly, the configuration for the 3D transformation equivariance architecture 500 illustrated in FIG. 5 has been designed to address this limitation by modifying the cross-attention module after the self-attention, enabling the decoding of higher frequency information. As a general description, the 3D transformation equivariance architecture 500 involves replacing the cross-attention module after the self-attention (which is included in the configurations shown in FIG. 3 and FIG. 4) to an invariant cross attention module 530. This enhancement to the 3D transformation equivariance architecture 500 aims to improve the model's expressive capacity and performance in handling complex patterns and details.

FIG. 5 illustrates that a configuration option for the framework for the 3D transformation equivariance architecture 500, which is referred to herein as an invariant cross-attention configuration. As shown in FIG. 5, the 3D transformation equivariance architecture 500 includes several elements and embeddings used to encode and decode information for translation of rotational transformations. In the example of FIG. 5, the equivariant cross-attention configuration for the 3D transformation equivariance architecture 500 includes: Equivariant Cross-Attention module 510, Equivariant Self-Attention with Fourier Transform module 520; and Equivariant Cross-Attention module 530.

The equivariant cross-attention module 510 has a function and structure that is substantially similar to the equivariant cross-attention module 310 previously described in reference to FIG. 3. Accordingly, for purposes of brevity, the details of the Cross-Attention module 510 are not described in detail again here in reference to FIG. 5.

Additionally, the equivariant self-attention without Fourier Transform module 520 has a function and structure that is substantially similar to the equivariant self-attention without Fourier Transform module 420 previously described in reference to FIG. 4. Accordingly, for purposes of brevity, the details of the equivariant self-attention without Fourier Transform module 520 are not described in detail again here in reference to FIG. 5.

One of the inputs to the equivariant cross-attention is the output hidden feature of the self-attention, which has the format (H₀, H₁, . . . Hₗₘₐₓ) a rotation R from H₁ can be learned through equivariant MLP and the Gram-Schmidt method. With the learned rotation R the inverse of R can be applied to the feature H, resulting in the transformed latent code (H₀, D¹(R)^{T}H₁, . . . , D^{lmax}(R)^{T}Hₗ). It can be verified that this transformed latent code is invariant to the rotation.

For the embedding of the query rays and camera, the invariant cross-attention module 530 is configured to first apply R^{T} to the ray rⱼⁱ and Tⁱ−T̅ to obtain invariant coordinates, denoted as R^{T}rⱼⁱ and R^{T}(Tⁱ−T̅). Then, the variant cross-attention module 530 can use the traditional positional encoding (cosine and sine) for these invariant coordinates, which allows higher frequency information to be leveraged. Since both the latent hidden state and the query are invariant to the transformation, this enables the 3D transformation equivariance architecture 500 to apply conventional cross-attention mechanisms to obtain invariant outputs and predictions, capturing higher frequency details and improving the expressive capacity of the model.

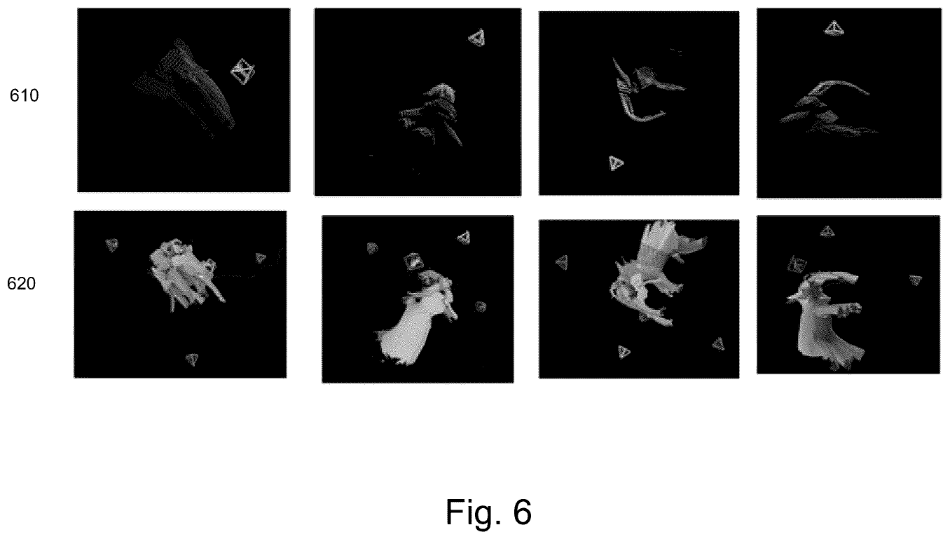

FIG. 6 depicts examples of depth estimations including equivariance in rotations within the 3D space that can be achieved by the 3D transformation equivariance systems and techniques disclosed herein. Particularly, FIG. 6 illustrates examples of depth estimations of an object that has been subjected to multiple various rotations, for example resulting from input of different cameras arranged at different angles around the object. FIG. 6 serves to illustrate that by achieving rotation equivariance, the 3D transformation equivariance system also ensures SE(3) equivariance.

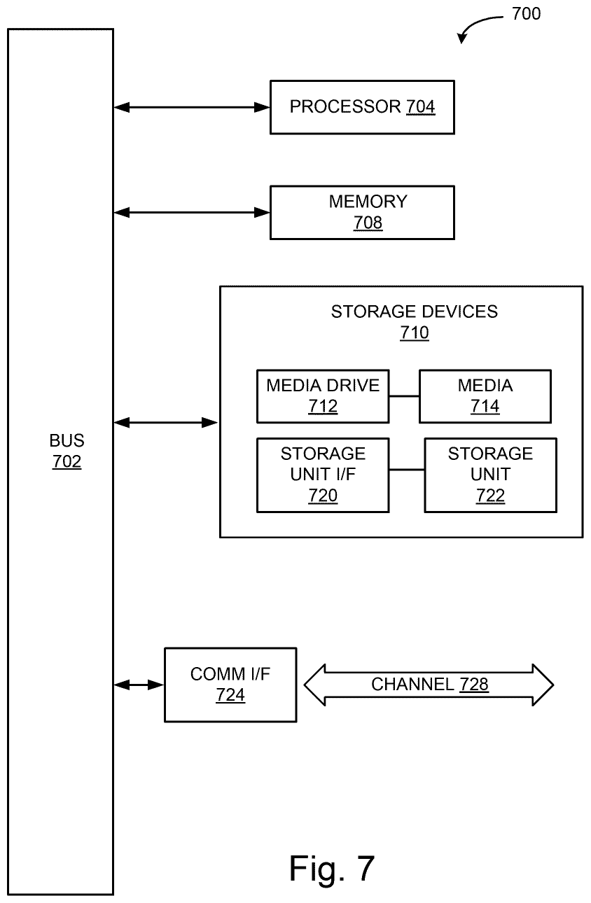

As used herein, a circuit or module might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. In other words, as would be apparent to one of ordinary skill in the art after reading this description, the various features and functionality described herein may be implemented in any given application and can be implemented in one or more separate or shared circuits in various combinations and permutations. Even though various features or elements of functionality may be individually described or claimed as separate circuits, one of ordinary skill in the art will understand that these features and functionality can be shared among one or more common circuits, and such description shall not require or imply that separate circuits are required to implement such features or functionality.

Where circuits are implemented in whole or in part using software, in one embodiment, these software elements can be implemented to operate with a computing or processing system capable of carrying out the functionality described with respect thereto. One such example computing system is shown in FIG. 7. Various embodiments are described in terms of this example-computing system 700. After reading this description, it will become apparent to a person skilled in the relevant art how to implement the technology using other computing systems or architectures.

Referring now to FIG. 7, computing system 700 may represent, for example, computing or processing capabilities found within desktop, laptop and notebook computers; hand-held computing devices (smart phones, cell phones, palmtops, tablets, etc.); mainframes, supercomputers, workstations or servers; or any other type of special-purpose or general-purpose computing devices as may be desirable or appropriate for a given application or environment. Computing system 700 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

Computing system 700 might include, for example, one or more processors, controllers, control modules, or other processing devices, such as a processor 704. Processor 704 might be implemented using a general-purpose or special-purpose processing engine such as, for example, a microprocessor (whether single-, dual- or multi-core processor), signal processor, graphics processor (e.g., GPU) controller, or other control logic. In the illustrated example, processor 704 is connected to a bus 702, although any communication medium can be used to facilitate interaction with other components of computing system 700 or to communicate externally.

Computing system 700 might also include one or more memory modules, simply referred to herein as main memory 708. For example, in some embodiments random access memory (RAM) or other dynamic memory, might be used for storing information and instructions to be executed by processor 704. Main memory 708 might also be used for storing temporary variables or other intermediate information during execution of instructions to be executed by processor 704. Computing system 700 might likewise include a read only memory (“ROM”) or other static storage device coupled to bus 702 for storing static information and instructions for processor 704.

The computing system 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), a flash drive, or other removable or fixed media drive might be provided. Accordingly, storage media 714 might include, for example, a hard disk, a floppy disk, magnetic tape, cartridge, optical disk, a CD or DVD, or other fixed or removable medium that is read by, written to or accessed by media drive 712. As these examples illustrate, the storage media 614 can include a computer usable storage medium having stored therein computer software or data.

In alternative embodiments, information storage mechanism 710 might include other similar instrumentalities for allowing computer programs or other instructions or data to be loaded into computing system 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory module) and memory slot, a flash drive and associated slot (for example, a USB drive), a PCMCIA slot and card, and other fixed or removable storage units 722 and interfaces 720 that allow software and data to be transferred from the storage unit 722 to computing system 700.

Computing system 700 might also include a communications interface 724. Communications interface 724 might be used to allow software and data to be transferred between computing system 700 and external devices. Examples of communications interface 724 might include a modem or softmodem, a network interface (such as an Ethernet, network interface card, WiMedia, IEEE 802.XX, Bluetooth® or other interface), a communications port (such as for example, a USB port, IR port, RS232 port, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 700 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle, comprising:
a processor device receiving image data of one or more objects having rotations in a three-dimensional (3D) space, wherein the 3D space is associated with a surrounding environment for the vehicle; and
a controller device performing equivariance of the image data in the 3D space from the processor device for image analysis and computer vision functions, and performing one or more autonomous operations in response to the image analysis and computer vision functions based on the equivariance.

2. The vehicle of claim 1, wherein the processor device comprises a 3D transformation equivariance component.

3. The vehicle of claim 2, wherein the 3D transformation equivariance component comprises spherical harmonics.

4. The vehicle of claim 3, wherein the spherical harmonics provide equivariance to rotations in the 3D space for input embeddings.

5. The vehicle of claim 4, wherein the equivariance of the image data comprises equivariance to simultaneous spatial transformations of input and output.

6. The vehicle of claim 3, wherein the 3D transformation equivariance component performs positional encoding with the spherical harmonics for input ray vectors and the translation of cameras associated with the image data.

7. The vehicle of claim 2, wherein the image data comprises image embeddings and camera embeddings.

8. The vehicle of claim 7, wherein the image data is captured by one or more vehicle cameras at the multiple viewpoints associated with rotations in the 3D space.

9. The vehicle of claim 1, wherein the processor device comprises a computer vision component performing one or more computer visual capabilities for the one or more autonomous operations.

10. The vehicle of claim 9, wherein the one or more computer visual capabilities comprise object detection.

11. The vehicle of claim 1, wherein the vehicle comprises an autonomous vehicle.

12. A system, comprising:
an equivariant cross-attention module encoding one or more image embeddings and one or more camera embeddings and outputting encoded information, wherein the encoding comprises positional encoding with spherical harmonics for input ray vectors and translation of cameras associated with the one or more image embeddings and the one or more camera embeddings.

13. The system of claim 12, further comprising:
an equivariant self-attention with Fourier Transform module applying features associated with the one or more image embeddings and the one or more camera embeddings as Fourier coefficients to obtain spherical features, and applying self-attention to the spherical features followed by a Fourier Transform to retrieve equivariant features.

14. The system of claim 13, further comprising:
an equivariant cross-attention module applying equivariant cross-attention after the self-attention to obtain invariant features for equivariance predictions.

15. The system of claim 14, further comprising:
an equivariant self-attention without Fourier Transform module obtaining equivariant features without sampling associated with a Fourier Transform.

16. The system of claim 15, wherein further comprising:
an invariant cross-attention after self-attention module applying invariant cross-attention after the self-attention enabling decoding of high frequency information to obtain invariant features for equivariance predictions.
